(19) United States
(12) Patent Application Publication
(10) Pub. No.: US 2004/0251184 A1
(43) Pub. Date: Dec. 16, 2004

(54) Fuel filter element

(76) Inventors: Wolfgang Buchhauser, Teugn (DE); Adolf Einberger, Rimbach (DE); Christoph Klesse, Worth A.D.Donau (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/882,753

(22) Filed: Jun. 30, 2004

Related U.S. Application Data
(63) Continuation of application No. PCT/DE03/00006, filed on Jan. 2, 2003.

(30) Foreign Application Priority Data
Jan. 7, 2002 (DE) 10200274.6

(51) Int. Cl. B01D 35/14

(52) U.S. Cl. 210/130; 210/433.1; 210/497.01

(57) ABSTRACT

A filter element for filtering fuel, in particular diesel fuel, in a motor vehicle comprises a by-pass (14, 26) with a sealing element (15, 21, 24), which opens on a given pressure difference between a region (19) before the filter element and a region (20) after the filter element being achieved.

### CROSS REFERENCE TO RELATED APPLICATION

This application is a continuation of copending International Application No. PCT/DE03/00006 filed Jan. 2, 2003 which designates the United States, and claims priority to German application no. 102 00 274.6 filed Jan. 7, 2002.

### TECHNICAL FIELD OF THE INVENTION

The present invention relates to filter element for filtering fuel, in particular diesel fuel, in a motor vehicle.

### DESCRIPTION OF THE RELATED ART

Currently what are known as mesh filters are used in diesel-operated motor vehicles and these are essentially cylindrical, with the filter function being executed predominantly at the lateral surface of the filter. Such mesh filters are predominantly used to protect a volume flow control valve, which controls a volume flow from a low-pressure pump to a high-pressure pump. As the volume flow control valve is very sensitive to impurities due to very fine component tolerances, the fuel must be directed via the mesh filter before it enters the volume flow control valve.

FIG. 5 shows a cylindrical mesh filter 4 according to the prior art. As shown in FIG. 5, the mesh filter 4 is arranged in a recess 13 in a housing 8. A supply line 9 or 9′ can thereby be arranged in the axial direction of the mesh filter 4 or in the radial direction of the mesh filter 4. The arrows shown in FIG. 5 thereby represent the direction of flow of the fuel. It should be noted that the first face 11 of the mesh filter 4 is sealed and the second face 12 of the mesh filter is open.

The efficiency of said mesh filter 4 depends essentially on the filter mesh size. A very small filter mesh size is however problematic, when the vehicle is still operated at cold external temperatures with a fuel, the CFPP (Cold Filter Plugging Point) value of which is higher than the current external temperature. This may for example be the case when the gas stations have not switched from summer diesel to winter diesel in good time or when the cold weather starts early or when a vehicle filled with summer diesel is not used again until the external temperatures are cold. In such cases the fact that the diesel fuel is not suitable for low temperatures causes paraffin solidification, which soon blocks the mesh filter. This impedes the supply to the high-pressure element of the pump. The high-pressure pump is able to supply the volume flow required to start the motor vehicle, so the engine starts to run, but the engine dies again after a few seconds, as the filter is blocked and insufficient fuel is delivered. The engine can therefore die again immediately after the motor vehicle starts due to blockage of the filter element. The motor vehicle can only be started again, when the fuel in the region of the mesh filter has heated up and the solidified fuel has dissolved.

It has been proposed that an electric heater be provided in the region of the fuel filter arranged in the pump supply system but this is not adequate to heat the fuel quickly so that the paraffin deposits at the mesh filter become liquid before the volume flow control valve. Also such a heater is relatively complex and cost-intensive.

### SUMMARY OF THE INVENTION

It is therefore the object of the present invention to provide a filter element for filtering fuel, which also allows passage through the filter element even when the filter element is blocked due to solidification of constituents of the fuel due to the temperature.

This object can be achieved by a filter element for filtering fuel in a motor vehicle, comprising a bypass with a sealing element, which opens when a predefined pressure difference is reached between a region before the filter element and a region after the filter element, whereby the bypass is an integral part of the filter element, and wherein the sealing element is configured as a pressure-relief joint.

The object can also be achieved by a filter for filtering fuel in a motor vehicle, comprising a filter element and a bypass with a sealing element integrated in said filter element, which opens when a predefined pressure difference is reached between a region before the filter element and a region after the filter element, wherein the sealing element is configured as a pressure-relief joint.

The sealing element may have an automatic reset. The pressure-relief joint may comprise a sealing lip on the side opposite the direction of flow. The pressure-relief joint can be configured on a region of the filter element made from plastic. The filter element can be configured as a cylindrical mesh filter. The bypass with the sealing element can be configured on a first face of the cylindrical mesh filter.

The inventive filter element for filtering fuel in a motor vehicle has the advantage compared with the prior art that it comprises a bypass, which opens when there is a predefined pressure difference between a region before the filter element and a region after the filter element. This means that when the filter element is blocked, fuel can flow via the bypass and avoid the filter element. This means in particular that a diesel motor vehicle can still be operated in cold external temperatures with a fuel, the CFPP value of which is higher than the current external temperature. If after a short time the temperature of the fuel then rises and the solidification due to the cold is then dissolved again in the fuel, the filter element is once again free and fuel can once again flow through the filter element. According to the invention a very small mesh size of for example approximately 30 μm can thereby be used for the filter element and the filter element still guarantees a passage function even if there are any paraffin deposits at the filter element. According to the invention the increasing pressure difference due to blockage of the filter element can be utilized for this purpose. When the defined pressure difference across the filter element is exceeded, the bypass is opened, thereby ensuring the function of the filter element. Therefore a very small mesh size can be used for the filter element according to the invention.

In order to provide a particularly compact structure, the bypass is preferably an integral part of the filter element. The filter element can hereby be configured as a cylindrical mesh filter for example, whereby the bypass is arranged on a face of the cylindrical mesh filter.

According to another preferred embodiment of the invention, the bypass is arranged parallel to the filter element, e.g. in the housing.

To ensure that once the bypass has opened, it does not remain open permanently, an automatic reset is preferably provided to seal the bypass again. This reset is preferably achieved by means of an elastic element.

The sealing element in the bypass is preferably configured as a non-return valve. The non-return valve is thereby particularly preferably configured as a spring-loaded seat valve with a ball as the valve element.

According to another preferred embodiment of the present invention the sealing element is configured as a tapering element, which rests on a tapering valve seat and is tensioned by means of a spring steel sheet.

According to another preferred embodiment the sealing element is provided in the form of a pressure-relief joint in one wall of the filter element. When a predefined pressure difference is reached between the region before the filter and the region after the filter, the pressure-relief joint ruptures so that the bypass is opened and fuel can flow past the filter devices of the filter element. The material from which the pressure-relief joint is configured is thereby flexible so that once the solidification causing the blockage has dissolved and there is a drop in the pressure difference between the regions before and after the filter element, the pressure-relief joint is once again sealed due to its elastic reset force. However it should be noted that a small gap or small passageways frequently remain open. For this reason a rubber-type lip is preferably provided at the pressure-relief joint, to cover the ruptured pressure-relief joint. The material from which the pressure-relief joint is configured, is preferably a plastic.

According to a further preferred embodiment of the present invention a butterfly valve arranged in a pivotable manner is preferably provided at the filter element. When a predefined pressure difference is reached between the regions before and after the filter element, this butterfly valve opens and once said pressure difference has been eliminated, it closes again automatically, e.g. by means of a spring element. Here too a sealing lip can preferably be arranged at the gaps in the butterfly valve to provide a better seal.

It is particularly preferable for the filter element to be configured as a cylindrical mesh filter, whereby the bypass with the sealing element is preferably arranged on a face of the mesh filter.

Therefore according to the invention a filter element can be provided with a graduated action when the filter becomes blocked due to solidification of paraffins in the fuel due to temperature. As such a constellation generally only occurs extremely rarely in the life cycle of a motor vehicle, the inventive bypass with sealing element does not have to be designed for frequent use. It can therefore be provided at particularly low cost. The cold start capability of a vehicle, which is to operate in particular with summer diesel in cold external temperatures, is therefore significantly improved according to the invention. The present invention means that the precise quality of the diesel fuel is no longer relevant. The present invention also allows a very small mesh size to be selected for the filter element, as the size of the mesh is not influenced by the cold start capability of the vehicle.

### BRIEF DESCRIPTION OF THE DRAWINGS

The present invention is described below with reference to preferred exemplary embodiments in conjunction with the drawing, in which:

FIG. 1 shows a schematic sectional view of part of a fuel delivery unit for a motor vehicle with a filter element according to a first exemplary embodiment of the present invention,

FIG. 2 shows an enlarged side view of the filter element shown in FIG. 1,

FIG. 3 shows an enlarged side view of a filter element according to a second exemplary embodiment of the present invention,

FIGS. 4a to 4c show views of a filter element according to a third exemplary embodiment of the present invention and

FIG. 5 shows a side view of a filter element according to the prior art.

### DETAILED DESCRIPTION OF THE PREFERRED EMBODIMENTS

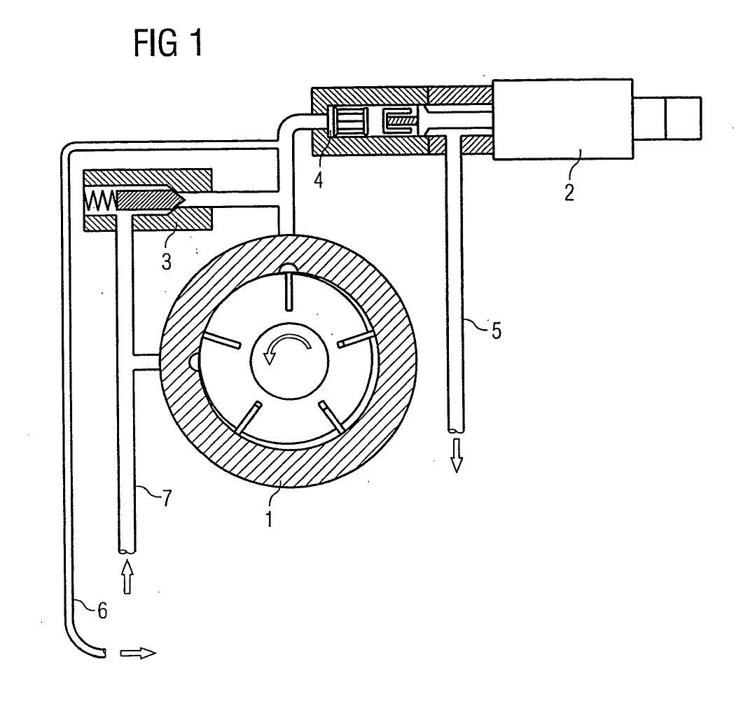

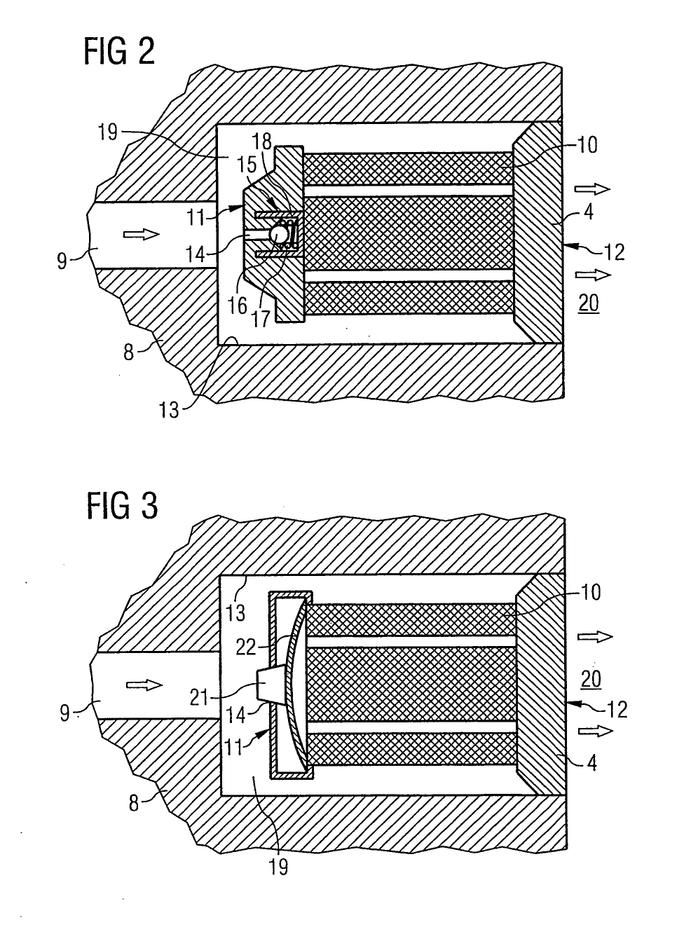

A filter element 4 according to a first exemplary embodiment of the present invention is disclosed below with reference to FIGS. 1 and 2.

As shown in FIG. 2, the filter element 4 according to the first exemplary embodiment is configured as a cylindrical mesh filter, which comprises a filter insert 10 with a small mesh size, which is configured as the lateral surface of the mesh filter 4 and a first face 11 and a second face 12.

FIG. 1 shows a functional diagram of an automatic high-pressure fuel pump with an inventive mesh filter 4. For the purpose of simplicity only the low-pressure region of said pump is shown in FIG. 1. The fuel is taken in by an internal mechanical pre-delivery pump 1 via the pump supply system 7 and brought to a higher pressure level. Some of the delivered fuel flows through the cylindrical mesh filter 4 to the volume flow control valve 2. This volume flow control valve 2 determines the quantity of fuel that has to reach the high-pressure element of the pump (not shown) via the line 5. Another part of the delivered fuel is delivered to a line 6 to flush the high-pressure pump. The pressure after the pre-delivery pump 1 is controlled via an internal pressure control valve 3. The quantity required for control purposes at the pressure control valve 3 is fed to the suction side of the pre-delivery pump 1.

As the volume flow control valve 2 is very sensitive to impurities due to its very strict component tolerances, the fuel is filtered by means of a mesh filter 4, before it enters the volume flow control valve 2. The efficiency of the mesh filter 4 thereby essentially depends on the filter mesh size. FIG. 2 shows the cylindrical mesh filter 4 in more detail. As shown in FIG. 2, the cylindrical mesh filter 4 comprises a filter insert 10 with a small mesh size, which provides the lateral surface of the mesh filter 4. The mesh filter 4 also comprises a first face 11 and a second face 12. The second face 12 has an opening and the volume flow control valve 2 is arranged on this face of the mesh filter 4 (see FIG. 1). The first face 11 represents the base of the mesh filter 4 and comprises a bypass 14 with a sealing element 15. The sealing element 15 seals the bypass 14 formed in the base of the mesh filter. The sealing element 15 comprises a valve ball 16, a helical spring 17 and a spring seat 18. The valve ball 16 is thereby pushed by the spring 17 onto its valve seat (see FIG. 2). The mesh filter 4 according to the first exemplary embodiment is thereby arranged in a recess 13 in a housing 8. As shown in FIG. 2, the flow is thereby fed to the mesh filter 14 in an axial direction via a filter supply line 9. It should be noted that the flow could of course also be fed to the mesh filter 4 radially.

The function of the mesh filter 4 according to the first exemplary embodiment, when a vehicle is started from cold with a fuel, the CFPP value of which is higher than the current external temperature, is as follows. When the engine is started, fuel can be delivered for a short period from the region of the pump downstream from the mesh filter. As the current external temperature is however lower than the CFPP limit, paraffin solidifies in the fuel and soon blocks the filter insert 10. In the prior art the fuel supply to the high-pressure pump would be terminated and the engine would die.

According to the invention however the blocking of the filter insert 10 causes a pressure difference Δp between a region 19 before the mesh filter 4 and a region 20 after the mesh filter. When this pressure difference Δp exceeds a predefined value, the sealing element 15 opens, in that the valve ball 16 is lifted from its seat against the spring force of the spring 17. The region 19 before the mesh filter 4 is thereby connected via the bypass 14 to the region 20 after the mesh filter 4. As a result fuel can flow directly out of the filter supply line 9 via the bypass 14 and the open sealing element 15 to the high-pressure pump.

It should be noted that the diameter of the bypass 14 must thereby be dimensioned so that the solidified paraffin in the fuel can pass through. It should also be noted that in this case, i.e. when the sealing element 15 is open, the fuel is not filtered and therefore fuel is delivered unfiltered to the high-pressure pump. This is however acceptable, as the state where the solidified paraffin is contained in the fuel only occurs extremely rarely during the life cycle of an engine unit or pump unit (for example when gas stations do not switch from summer to winter diesel in good time or when a vehicle filled with summer diesel is not moved again until the external temperatures are cold).

Once the fuel is heated by the operation of the engine, the paraffin deposits dissolve again in the fuel, so the filter insert 10 is no longer blocked by solidified paraffin and the fuel can again flow through the filter insert 10. As a result the pressure in the region 20 after the mesh filter 4 rises again, so the pressure difference Δp drops and the sealing element 15 is again sealed by means of the spring 17. This means that the bypass 14 is sealed again and the fuel can only flow when filtered via the filter insert 10 of the mesh filter 4.

The time of opening or sealing of the bypass 14 can thereby be adjusted as required as a function of the spring force of the spring 17.

The cold start capability of the motor vehicle is therefore significantly improved according to the invention and the precise diesel fuel quality is no longer relevant. It is also possible according to the invention to avoid using too large a mesh size for the filter insert 10, as used in the prior art to prevent the filter insert 10 from becoming blocked. The inventive filter element can thereby provide a significantly improved filter action as well as the improved cold start capability. A mesh size of 30 μm can for example be used for the inventive filter element.

It should be noted that the bypass 14 can either be an integral part of the filter element 4 or can also be configured adjacent to the filter element.

A filter element according to a second exemplary embodiment of the present invention is disclosed below with reference to FIG. 3.

Identical and functionally identical parts are thereby again assigned the same reference characters as in the first exemplary embodiment.

The second exemplary embodiment corresponds essentially to the first exemplary embodiment. Unlike the first exemplary embodiment, in the second exemplary embodiment the bypass is formed by an opening 14 on the first face 11 of the mesh filter 4. The opening 14 is sealed by a conical sealing element 15, which seals the opening 14 by means of a spring steel sheet 22. Otherwise the structure of the second exemplary embodiment essentially corresponds to that of the first exemplary embodiment so a more detailed description of the structure of said filter element is not necessary.

The function of the mesh filter 4 according to the second exemplary embodiment is also similar to the function of the filter element according to the first exemplary embodiment. When the filter insert 10 becomes blocked, the resulting pressure difference between the region 19 before the filter and the region 20 after the filter causes the bypass 14 to open. The conical sealing element 21 is pushed from its seat against the spring force of the spring steel sheet 22 due to the pressure difference, thereby allowing a direct flow from the region 19 to the region 20. When the solidification blocking the filter insert 10 has dissolved and the pressure difference between the regions before and after the filter has dropped, the sealing element 21 resets itself automatically due to the spring force of the spring steel sheet 22 and seals the bypass 14. Only fuel filtered through the filter insert 10 can then be delivered to the high-pressure pump.

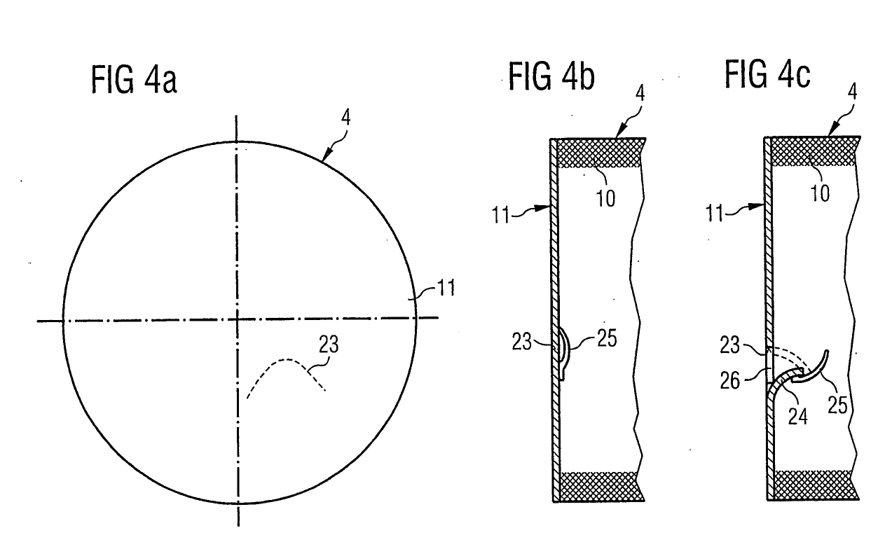

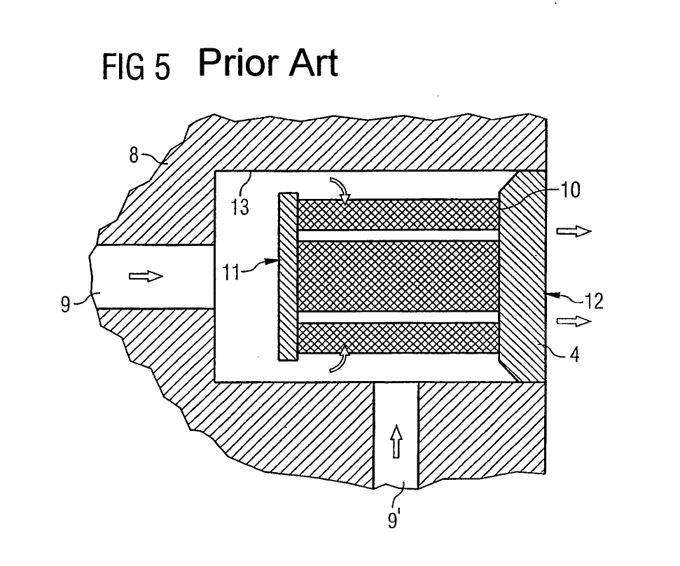

A filter element according to a third exemplary embodiment of the present invention is disclosed below with reference to FIGS. 4a, 4b and 4c. Identical or functionally identical parts are thereby again assigned the same reference characters as in the first exemplary embodiment.

Unlike the preceding exemplary embodiments, the filter element according to the third exemplary embodiment has a pressure-relief joint 23. A sealing lip 25 is also provided within the mesh filter 4, which is made from a rubber-type elastic material and is arranged over the pressure-relief joint 23 to seal it.

FIG. 4a shows a top view of the first face 11 of the mesh filter 4. The pressure-relief joint 23 is thereby formed in a curved shape anywhere on the first face 11. If the filter insert 10 now becomes blocked due to solidification caused by temperature and a defined pressure difference between the regions before and after the mesh filter 4 is exceeded, the pressure-relief joint 23 ruptures, as shown in FIG. 4c. As a result the fuel can flow through the opening 26 thus formed to the high-pressure pump without being filtered through the mesh filter 4.

When the temperature of the fuel rises and the solidification dissolves back into the fuel, the pressure difference between the regions before and after the mesh filter 4 drops, so that the curving section 24 at the pressure-relief joint 23 is reset to its initial position due to its inherent elasticity. As the pressure-relief joint 23 has however been ruptured, a small gap remains in the first face 11. However the sealing lip 25 is now provided to cover this gap. This prevents impurities being able to pass into the region after the mesh filter 4 through the gap resulting at the pressure-relief joint. It should be noted that the first face 11 is preferably made from plastic, so that the inherent elasticity of the curved section 24 can easily be provided. It should also be noted that the pressure-relief joint can have any geometric form. It should only be ensured that adequate reset force is provided by the curved section after rupture of the pressure-relief joint. The region of the filter comprising the pressure-relief joint is therefore preferably made from plastic.

The present invention therefore relates to a filter element for filtering fuel, in particular diesel fuel, in a motor vehicle. The filter element comprises a bypass 14, 26 with a sealing element 15, 21, 24, which opens when a predefined pressure difference Δp is reached between a region 19 before the filter element and a region 20 after the filter element.

The present invention is not restricted to the exemplary embodiments shown. Various differences and modifications can be executed without departing from the scope of the invention.

We claim:

1. A filter element for filtering fuel in a motor vehicle, comprising a bypass with a sealing element, which opens when a predefined pressure difference is reached between a region before the filter element and a region after the filter element, whereby the bypass is an integral part of the filter element, and wherein the sealing element is configured as a pressure-relief joint.

2. The filter element according to claim 1, wherein the sealing element has an automatic reset.

3. The filter element according to claim 1, wherein the pressure-relief joint comprises a sealing lip on the side opposite the direction of flow.

4. The filter element according to claim 2, wherein the pressure-relief joint comprises a sealing lip on the side opposite the direction of flow.

5. The filter element according to claim 1, wherein the pressure-relief joint is configured on a region of the filter element made from plastic.

6. The filter element according to claim 1, wherein the filter element is configured as a cylindrical mesh filter.

7. The filter element according to claim 6, wherein the bypass with the sealing element is configured on a first face of the cylindrical mesh filter.

8. A filter for filtering fuel in a motor vehicle, comprising
a filter element;
a bypass with a sealing element integrated in said filter element, which opens when a predefined pressure difference is reached between a region before the filter element and a region after the filter element, wherein the sealing element is configured as a pressure-relief joint.

9. The filter element according to claim 8, wherein the sealing element has an automatic reset.

10. The filter element according to claim 8, wherein the pressure-relief joint comprises a sealing lip on the side opposite the direction of flow.

11. The filter element according to claim 9, wherein the pressure-relief joint comprises a sealing lip on the side opposite the direction of flow.

12. The filter element according to claim 8, wherein the pressure-relief joint is configured on a region of the filter element made from plastic.

13. The filter element according to claim 8, wherein the filter element is configured as a cylindrical mesh filter.

14. The filter element according to claim 13, wherein the bypass with the sealing element is configured on a first face of the cylindrical mesh filter.
